(19) United States
(12) Patent Application Publication
(10) Pub. No.: US 2005/0109207 A1
(43) Pub. Date: May 26, 2005

(54) Method and apparatus for the recovery of volatile organic compounds and concentration thereof

(76) Inventors: W. Karl Olander, Indian Shores, FL (US); Jose I. Arno, Brookfield, CT (US)

Correspondence Address: ATMI, INC., 7 COMMERCE DRIVE, DANBURY, CT, 06810, US

(21) Appl. No.: 10/720,398

(22) Filed: Nov. 24, 2003

(51) Int. Cl. B01D 53/02

(52) U.S. Cl. 95/141; 96/121; 96/115; 96/130

(57) ABSTRACT

A gas recovery apparatus and method for reclaiming and concentrating volatile organic compounds from the effluent of a semiconductor manufacturing operation is described. Vacuum Swing Adsorption is used to treat effluent containing volatile organic compounds to reversibly capture and subsequently release the volatile organic compounds, followed by recycle and/or cogeneration of the captured volatile organic compounds.

### BACKGROUND

The present invention relates to a method and apparatus for recovering and concentrating constituents, e.g. volatile organic compounds, of effluent streams from semiconductor manufacturing operations, for purification, reuse and/or cogeneration of power, while concurrently improving the efficiency of effluent stream abatement.

### DESCRIPTION OF THE RELATED ART

Many semiconductor processes, including spin coating of photoresist materials and azeotropic drying of wafers with alcohols, produce quantities of volatile organic compounds (VOCs) including, but not limited to, isopropanol, ethylacetate, acetone, propylene glycol monomethyl ether acetate (PGMEA) and hexamethyldisilazane (HMDA). Typically, the concentration of VOCs emitted from a semiconductor manufacturing process range from about 20 ppm to about 200 ppm in an effluent flow at least 10,000 CFM. Because VOCs are detrimental to human health and the environment, stricter legislative controls regarding emissions of VOC-containing effluent streams have been promulgated and strictly enforced.

As a result of increased controls, the capital costs of the semiconductor manufacturing process facility have increased, including energy costs to effect recovery and destruction of VOCs prior to emission of the effluent stream into the environment. Removing VOCs from large volumes of effluent stream using commonly used techniques such as catalytic recuperative oxidation, regenerative thermal oxidation and rotary concentration with thermal oxidation can be economically burdensome.

Catalytic oxidation processes, wherein VOCs are oxidatively converted to the combustion products carbon dioxide and water, are in increasingly widespread use as a result of their high efficiency and cost-effectiveness. In operation, a VOC-containing effluent stream is heated to an appropriate elevated temperature in the presence of catalyst material to effect oxidation of the VOCs in the effluent stream. The catalytic oxidation process is strongly exothermic in character, so substantial heat is generated during oxidation. Accordingly, economic operation of the catalytic oxidation process requires that the process be autothermal in character, wherein the heat generated during the oxidation of the effluent gas stream is recovered and reused within the process for heating as-yet-untreated effluent gas to an appropriate elevated temperature. Notably, because of fluctuations in the volume and composition of the effluent stream, catalytic oxidizers tend to be greatly oversized.

Holst et al. (U.S. Pat. No. 5,914,091) describes a point-of-use VOC abatement system arranged to treat effluent flowing from a single workstation unit or tool, wherein VOCs in the effluent are catalytically oxidized. Unlike prior art autothermal catalytic oxidation systems that treat substantially diluted, “end-of-the-pipe” effluent streams, the concentration of VOCs in the effluent of the point-of-use abatement system is substantial enough that the system is energy sustaining, therefore requiring essentially no external heat energy for effective catalytic oxidation.

Another common VOC control method is thermal oxidation. A typical thermal oxidizer feeds air containing the pollutant to be removed into a combustion chamber where it is mixed with enough natural gas to sustain combustion. It has been reported that the cost of operating this type of device in a typical U.S. industrial plant easily adds 25% to the yearly energy bill. Additionally, these oxidizers tend to have large footprints and are economically burdensome due to the complexity of the system.

The removal of VOCs from effluent streams using adsorption is most often accomplished using thermal swing adsorption (TSA), wherein the adsorbed VOCs are driven off by heating the adsorbent bed, e.g., using heating coils embedded in the adsorbent bed or passing steam through the adsorbent bed, simultaneously regenerating the adsorbent bed for subsequent reuse. Following desorption, the regenerated adsorbent must be cooled by the passage of cooling gas through the bed prior to subsequent reuse. Notably, it has been reported that at concentration levels less than 500 ppm or greater than 15,000 ppm, recovery of VOCs from effluent by TSA is not economically justifiable. Concentrations of VOCs above 15,000 ppm are typically in the explosive range thus requiring the use of a hot inert carrier gas, while recovery of VOC concentrations below about 500 ppm is technologically infeasible and hence economically burdensome.

Munters Zeol combined adsorption technology with catalytic oxidation to abate low concentrations of VOCs. The Munters Zeol adsorber utilizes a wheel embedded with a mixture of hydrophobic zeolites, wherein VOCs in the effluent are adsorbed onto the zeolite material and subsequently desorbed in a desorbing zone as a concentrated stream using a reduced volume of hot air. The wheel turns several revolutions per hour, passing through the desorbing zone each revolution thereby “regenerating” itself for subsequent VOC adsorption. Disadvantages of the Munters Zeol technology include a sizeable footprint and a concentration ratio of only about 10:1. As such, small amounts of VOCs remain in a large volume of effluent. Further, because desorption and regeneration is accomplished using hot air, the desorbing zone must cool down before it can efficiently re-adsorb VOCs.

Zarchy et al. (U.S. Pat. No. 5,512,082) describe a vacuum swing adsorption (VSA) process for the removal of VOCs from a fluid stream to recover a liquid VOC product while yielding an effluent essentially free of VOCs. To effectuate recovery of VOCs a series of complicated steps are repeated in a continuous operation including: adsorption of the VOCs from the feedstream; copurge; countercurrent evacuation; and separation of the tail gas stream into a VOC-containing stream and a residual gas stream.

Maese et al. (U.S. Pat. No. 5,832,713) describe a method and apparatus for the destruction of VOCs, wherein the VOC destruction device is a power generator. The power generator utilizes a primary fuel supply, such as natural gas, which is mixed with a secondary fuel supply including air and VOCs. The fuel mixture of primary and secondary fuels is then burned in the power generator. It is disclosed that the power generated is sufficient to run the power generator compressor while simultaneously provide up to an additional 525 kW of electricity. Disadvantages of this method include that the high costs of operation are merely shifted from electricity to fuel. Additionally, when the amount of VOCs in the air varies over time, the system is largely uncontrollable.

It is apparent that the removal and destruction of VOCs from the effluent stream of a semiconductor manufacturing process remains an obstacle that adversely impacts the economics of conventional semiconductor manufacturing facilities.

Accordingly, there is a compelling need in the art for improved approaches that will efficaciously remove and concentrate VOCs from the effluent streams of a semiconductor manufacturing operation while simultaneously reducing the capital costs associated with such removal and concentration.

### SUMMARY OF THE INVENTION

The present invention relates generally to the recovery of VOCs from the effluent stream of a semiconductor manufacturing operation, e.g., for collection in a concentrated form relative to the bulk effluent from which the VOCs are derived, for reclamation and cogeneration or for further processing or alternative use of such VOCs.

In one aspect, the present invention relates to a gas reclamation system for capturing volatile organic compounds from an effluent of a semiconductor manufacturing operation, said system comprising:
a reversible capture unit arranged to capture volatile organic compounds from the effluent and to selectively release the captured volatile organic compounds in concentrated form, wherein the reversible capture unit comprises a physical adsorbent having a selective sorptive affinity for the volatile organic compounds; and
a vacuum desorption unit arranged to desorb volatile organic compounds from the physical adsorbent in concentrated form.

In another aspect, the present invention relates to a gas reclamation system for capturing volatile organic compounds from an effluent of a semiconductor manufacturing process for cogeneration, said system comprising a physical adsorption unit including at least one adsorber vessel containing a physical adsorbent having selective sorptive affinity for the volatile organic compounds, wherein the physical adsorption unit is arranged to receive effluent containing volatile organic compounds, for selective adsorption of volatile organic compounds on adsorbent therein, and to subsequently desorb volatile organic compounds from the physical adsorption unit; and a power generator coupled to the physical adsorption unit and arranged for receiving a desorbate at least partially concentrated in volatile organic compounds from the physical adsorption unit to generate electricity.

In a further aspect, the present invention relates to a process for improving the efficiency of abatement and/or implementing reclamation and concentration of volatile organic compounds in an effluent of a semiconductor manufacturing process, said process comprising:
capturing the volatile organic compounds from said effluent in concentrated form, wherein the capturing step comprises use of adsorbent bed(s) for capture of the volatile organic compounds; and
releasing the adsorbed volatile organic compounds by vacuum desorption.

Yet another aspect of the invention relates to a method of reclamation and cogeneration of volatile organic compounds in an effluent of a semiconductor manufacturing process comprising:
collecting the effluent containing volatile organic compounds;
selectively adsorbing the volatile organic compounds from the effluent at least partially concentrated in the volatile organic compounds on a physical adsorbent therein;
desorbing volatile organic compounds from the adsorbent to produce a stream of captured volatile organic compounds;
combusting the captured volatile organic compounds in a combustor to substantially destroy the captured volatile organic compounds and create a resulting stream of combustion gas;
directing said resulting stream of combustion gas to drive a power generator; and
recovering power from operation of said power generator.

Other aspects, features and embodiments of the invention will be more fully apparent from the ensuing disclosure and appended claims.

### BRIEF DESCRIPTION OF THE DRAWINGS

FIG. 1 is a schematic representation of a reclamation and concentration system according to one embodiment of the invention, as illustratively employed for the recovery and concentration of VOCs from the effluent of a semiconductor manufacturing process.

FIG. 2 is a schematic representation, taken in elevational cross-section, of a cryotrap reclaimer unit adapted for recovery of chemical reagents from the effluent of a semiconductor manufacturing operation.

### DETAILED DESCRIPTION OF THE INVENTION, AND PREFERRED EMBODIMENTS THEREOF

The method and apparatus of the present invention are usefully employed for recovery and concentration of Volatile Organic Compounds (VOCs) from the exhaust stream of a semiconductor manufacturing operation, thereby reclaiming VOCs which, in the absence of the recovery and concentration approach of the present invention, would simply pass through the facility and be discharged to the facility's waste treatment system(s), e.g., a central oxidizer unit of a semiconductor facility.

The method and apparatus of the invention correspondingly achieve a substantial reduction in the cost of manufacturing semiconductor products, by achieving reductions in the requirements of effluent abatement and disposal for the semiconductor manufacturing facility. Since the recovered VOCs have value when reclaimed and reused, the present invention also achieves a substantial reduction of costs of production for the semiconductor manufacturing facility. For example, VOCs can be reclaimed in concentrated form and subsequently used to cogenerate electricity, which can be used to operate the reclamation and concentration system. Additionally, the reclaimed VOCs can be recycled, thereby reducing the waste generation costs and requirements of the semiconductor manufacturing facility. The net result is a semiconductor manufacturing operation that achieves major economic and operational gains.

Capture and concentration of VOCs produced in the semiconductor manufacturing process are achieved in the practice of the present invention, and contribute to further lowering of abatement costs. For example, the recovery of greater than 96% of the VOCs from the process effluent permits the VOC-depleted effluent, e.g., air, to be exhausted directly to the atmosphere. Further, captured and concentrated VOCs can be destroyed using far less energy than would be the case if the untreated effluent stream were simply treated using conventional thermal oxidation methods. Accordingly, the invention provides an environmentally favorable abatement solution, while concomitantly reducing costs associated with remediation.

Additionally, the economic and operational impact of the apparatus of the invention is reduced owing to the small footprint and decreased setup and maintenance costs.

The term “volatile organic compounds,” or VOCs, refers to hydrocarbons, including saturated, unsaturated, and aromatic; oxygenated materials such as alcohols, esters, ethers, and acids; nitrogen containing compounds (principally amines); sulfur containing materials (mercaptans and thioethers); and halogen-containing materials, especially chlorine-substituted hydrocarbons but also organic fluorides and bromides.

The term “captured VOCs” refers to VOC compounds present and subsequently removed from the effluent stream of a semiconductor manufacturing operation by one of the methods taught herein. Preferably, the captured VOCs have a high fuel value for cogeneration.

In general, within the semiconductor industry, VOCs are generated at atmospheric pressure in processes including, but not limited to, photoresist spin coating, isopropanol dryers to remove water during wet etching operations, wet bench photoresist strip tools, solvent baths and solvent washing stations. In each case, the volumetric flow of effluent can be substantial, e.g., at least 10,000 CFM, while the concentration of VOCs therein is generally low, e.g., 20 ppm to 200 ppm.

The process and apparatus of the invention are directed broadly to reversible capture and concentration of VOCs in the effluent stream of a semiconductor manufacturing operation or a unit operation or specific tool therein, with such capture and concentration being effected at a capture locus such as a physical adsorbent bed, cold finger, cryotrap, membrane separation unit, etc., and recycle thereof for reuse in the semiconductor manufacturing facility or off-site.

The process and apparatus of the invention can take numerous variant forms as hereinafter described in greater detail. By way of non-limiting illustrative examples, such process and apparatus can in specific embodiments be arranged for: cryotrap capture of VOCs, in which the captured material from the cryotrap is recovered in any suitable manner, e.g., by simple warming of the cryotrap and volatilization of the captured material; membrane separation and recovery of VOCs; use of adsorbent bed(s) for capture of VOCs, where the adsorbent medium may be a carbon sorbent material or alternatively a non-carbon sorbent material, and the adsorbent bed(s) are desorbed of the sorbate VOCs by suitable desorption processes, e.g., heat-mediated desorption or vacuum desorption.

In one embodiment, a semiconductor manufacturing effluent is processed for recovery and concentration of VOCs, in a system in which the effluent stream of the semiconductor manufacturing operation is contacted with a physical adsorbent medium having physically adsorptive affinity for VOC species, to thereby remove the VOCs from the effluent stream. A blower is sited upstream or downstream of the adsorbent beds to provide the motive force needed to contact the effluent with the physical adsorbent medium.

The physical adsorbent contacting step can be effected by flowing the effluent stream through an adsorber vessel containing a bed of the physical adsorbent material, and sorptively removing the VOCs, to produce a VOC-depleted effluent stream. The VOC-depleted effluent stream is typically air and as such is exhausted directly to the atmosphere.

The adsorbent contacting can be advantageously effected using a vacuum swing adsorption (VSA) system, in which the adsorbed VOC species are removed in concentrated form from the adsorber bed of the VSA system, using a vacuum pump to effect release of the adsorbed VOC species from the adsorbent. The vacuum pressure utilized in the practice of this invention can be chosen to maximize the fuel value of the desorbed VOCs. Preferably, the vacuum used is less than about 700 Torr, more preferably less than about 500 Torr, most preferably between about 100 Torr and about 50 Torr.

The adsorption system, e.g., of a vacuum swing character, can be arranged with a multiplicity of adsorbent vessels, each containing a bed of the physical adsorbent medium, and arranged so that while one or more adsorbent vessels is “on-stream” and processing effluent for removal of VOCs therefrom, other(s) of such adsorbent vessels are being regenerated, to renew them for active on-stream operation. Preferably, the adsorbent beds are “swung” every few minutes to reduce the size of the adsorption system. Alternatively, a rotary adsorption system, such as the Munters Zeol HoneyCombe® rotor (Munters, Zeol Division, Amesbury, Mass.) or the Seibu Giken “PURO-SAVE” VOC Concentrator (Seibu Giken Co., Ltd., Japan), may be employed wherein the revolution of the rotor permits adsorption of VOCs from the effluent and simultaneous regeneration in the desorbing zone.

The VOC-depleted effluent stream after the adsorbent contacting operation is air that can be simply exhausted to the atmosphere.

Once captured by adsorption, the retained sorbate VOC gases can then be collected by removing them from the sorbent medium, e.g., by vacuum desorption, using a suitable vacuum pump. Thereafter, the concentrated VOCs from the sorbent medium can be fed to a cogenerator for exploitation therein. Alternatively, the extracted VOC species from the adsorbent can be sent to a container for transport of the VOC species to a further use facility, e.g., when the recovered VOC species are at a purity suitable for other industrial application(s).

In yet another alternative, the recovered VOCs, being in concentrated form in relation to the effluent from which they were removed, are in form for efficient waste destruction and disposal, by virtue of the reduced volume relative to the bulk effluent discharged from the semiconductor manufacturing process.

In a further alternative, the VOC species extracted from the adsorbent can be purified in a purification unit and recycled, or sent to other use or disposition.

During desorption of the VOCs from the adsorbent bed, the beds are “regenerated,” wherein previously occupied adsorption sites are available again for “on-stream” processing. Regeneration can further involve purging of the adsorber vessel after desorption of the VOCs from the adsorbent bed in the vessel, with a suitable purge gas, preferably inert, such as nitrogen. The presence of nitrogen gas during purging has the added benefit of maintaining the VOC concentration below the lower VOC explosive limit.

Cogeneration involves directing the captured VOCs into a microturbine type power generator such as, but not limited to, the Capstone Turbine (Capstone Turbine Corp., Chatsworth, Calif.), wherein the captured VOCs undergo combustion creating a stream of exhaust gas which drives a turbine, thus generating electricity. The captured VOCs are oxidized in the absence of secondary fuels, e.g. natural gas, methane etc., or in the alternative, secondary fuels can be added when the concentration of captured VOCs is not great enough to sustain combustion. Following combustion, the by-products are carbon dioxide and water and thus are substantially completely free of toxic or otherwise hazardous components for discharge directly to the atmosphere.

Another advantage of the VOC reclamation and concentration system of the present invention is that the collection/recovery process can be operated under vacuum pressures or atmospheric pressure, so that release of VOC species from the reclamation system will be diffusionally limited in a worst case, in the event of a leak or flow circuitry failure in the reclamation system.

It will be appreciated that numerous configurations of the reclamation and concentration system of the invention are possible within the broad scope of the present invention, as will be more fully apparent from the ensuing description of illustrative embodiments and features of the invention.

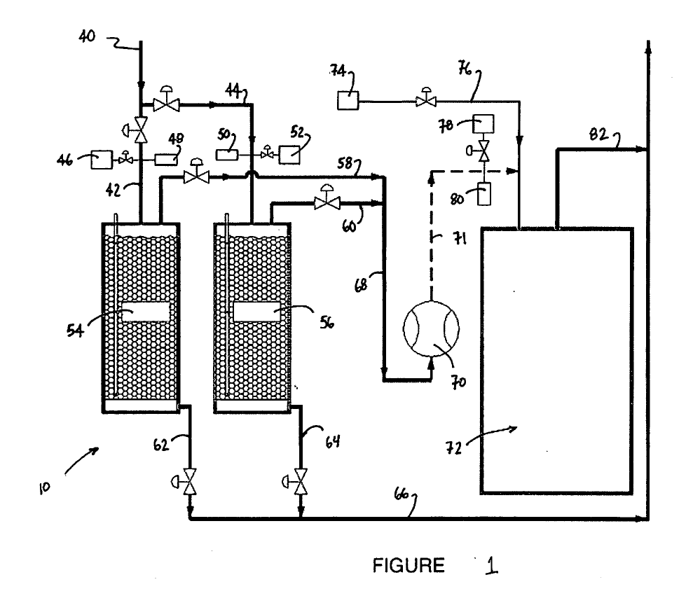

Referring now to the drawings, FIG. 1 is a schematic representation of a reclamation and concentration system 10 according to one embodiment of the invention, as illustratively employed for recovery and concentration of VOCs from the effluent of a semiconductor manufacturing process.

The reclamation and concentration system is arranged to receive the effluent stream from semiconductor manufacturing operations including, but not limited to, photoresist spin coating, isopropanol dryers to remove water during wet etching operations, wet bench photoresist strip tools, solvent baths and solvent washing stations.

The effluent stream from the semiconductor manufacturing operation 40 is flowed to the manifolded adsorber system, through the valved inlet manifold 42 or 44 to one of the adsorbent vessels 54 or 56, depending on the valving configuration (i.e., depending on which of the valves in the inlet manifold 42 or 44 is open and which of such valves is closed). An effluent blower may be sited upstream, e.g., in manifold 40, or downstream, e.g., in manifold 66, of the adsorber system to motively force the effluent stream to the adsorbing beds. The manifolded adsorber system is arranged so that only one of the adsorbent vessels 54 or 56 is actively receiving the concentrated VOC stream at a given time.

Each of the adsorbent vessels 54 and 56 is filled with a physical adsorbent material, e.g., in the form of a bed of such material in particulate form. Alternatively, the physical sorbent material may be permanently formed in a honeycomb shape to reduce pressure drop across the sorbent material. The physical adsorbent material has sorptive affinity for VOCs, and upon flowing the VOC-containing effluent stream through the active, on-stream adsorbent bed, the VOCs are selectively adsorbed on the adsorbent medium. Such physical adsorbent material can for example comprise: a carbon sorbent, e.g., activated carbon, bead activated carbon, or a modified carbon containing trace metal or other species; molecular sieve; alumina; silica; kieselguhr; clays; porous polymeric or metallic media; porous silicon; zeolites (hydrophobic and hydrophilic); etc. The adsorbent bed(s) can also include mixtures of different types of sorbent media, and such sorbent media can include chemisorbent material arranged in series or interspersed with physical adsorbent media. Preferably, for VOC adsorption the adsorbent material comprises carbon or a mixture of hydrophobic zeolites. The requisite surface area of physical adsorbent material appropriate under semiconductor manufacturing operation flow conditions and VOC loading can be readily determined by experiment within the skill of the art.

The term “zeolite” in general refers to a group of naturally occurring and synthetically hydrated metal aluminosilicates, many of which are crystalline in structure. There are, however, significant differences between the various synthetic and natural materials in chemical composition, crystal structure and physical properties such as x-ray powder diffraction patterns. The zeolites occur as agglomerates of fine crystals or are synthesized as fine powders and are preferably tableted or pelletized for large-scale adsorption uses.

Typical well-known zeolites which may be used include, but are not limited to, chabazite, also referred to as Zeolite D, clinoptilolite, erionite, faujasite, also referred to as Zeolite X and Zeolite Y, ferrierite, mordenite, Zeolite A, and Zeolite P. Other zeolites suitable for use according to the present invention are those having a high silica content, i.e., those having silica to alumina ratios greater than 10 and typically greater than 100. Detailed descriptions of some of the above-identified zeolites may be found in D. W. Breck, Zeolite Molecular Sieves, John Wiley and Sons, New York, 1974.

Optionally, pressure sensors 48 or 50 are incorporated in the valved inlet manifold 42 or 44, respectively, to monitor the pressure during adsorption and/or regeneration to ensure that the system is operating properly. Preferably, gas vessels 46 and 52 contain compressed air or inert gases such as nitrogen.

As a result of the adsorption of the VOCs in the active on-stream adsorbent bed, the effluent is substantially depleted of VOCs, and the resulting VOC-depleted effluent stream is discharged from the active adsorbent bed into the valved outlet manifolds 62 or 64. From the valved outlet manifolds 62 or 64, the VOC-depleted effluent stream, e.g., air, is flowed in line 66 for exhaust to the atmosphere.

While the active, on-stream adsorbent bed is receiving the dilute VOC stream for sorptive removal of the VOCs, the other of the adsorbent beds 54 and 56 is off-stream, and undergoes desorption/regeneration during the off-stream period of the processing cycle.

The regeneration process involves actuation of the vacuum desorption pump 70, which is coupled with the valved desorption manifolds 58 and 60 by means of desorption line 68. During regeneration, the VOCs captured by the adsorbent beds are desorbed as a concentrated stream of VOCs along valved desorption manifolds 58 and 60 upon actuation of the vacuum desorption pump 70. Preferably, the concentrated stream of VOCs have a high fuel value. With desorption, the adsorbent bed is “regenerated,” meaning a substantial number of VOC adsorption sites are available again for on-stream processing.

The two bed arrangement of adsorbent beds thus permits one of the two beds to be actively processing effluent while the other bed is being subjected to vacuum desorption by action of the vacuum pump 70. The two bed arrangement provides a concentration ratio of VOCs in the effluent of about 50:1 to about 150:1, preferably about 75:1 to about 125:1, most preferably about 100:1.

Concentrated VOCs of appropriately high fuel value can be flowed from vacuum desorption pump 70 in line 71 and mixed in line 76 with combustion promoting gases, e.g., gas comprising oxygen, from vessel 74. The mixture of captured VOCs and combustion promoting gases subsequently enters the power generator 72 and undergoes combustion, producing an exhaust gas stream which drives a turbine thus generating electricity.

As will be appreciated by one skilled in the art, the fuel-to-air ratio should be chosen to ensure that the combustion flame is not too rich or too lean. By way of example, the power generator preferably comprises a gas turbine engine capable of producing 30 kW to 60 kW of electricity. Additionally, the gas turbine engine should be operative at inlet pressures as low as 0.2 psig.

Optionally, a total organic carbon sensor 80 can be incorporated in line 71 downstream of vacuum desorption pump 70 to monitor the concentration of the captured VOC stream. It is known in the art that self combustion cannot be maintained if the VOC concentration is 500 ppm or less. Preferably, the concentration of concentrated VOCs in the line 71 is about 1000 ppm or greater. If the pressure of the captured VOC stream is too low, signaling that the concentration of captured VOCs is too low, a requisite volume of secondary fuel, e.g. natural gas, methane, etc., from vessel 78 can be added to line 71 prior to mixing with the combustion promoting gases in line 76. The fuel needed to sustain combustion within the power generator should comprise about 50% to about 100% concentrated VOCs, preferably about 75% to about 100% concentrated VOCs, most preferably about 90% to about 100% concentrated VOCs. Alternatively, the volume of secondary fuel can be constant wherein the microturbine output fluctuates with changing VOC concentrations.

The VOC-depleted exhaust 82 from the power generator 72 contains carbon dioxide and water and is vented into line 66 for exhaust directly into the atmosphere. The electricity generated in power generator 72 can be used within the semiconductor manufacturing facility to operate the reclamation and concentration systems.

In another embodiment, the VOCs desorbed from the adsorbent beds during regeneration along valved desorption manifolds 58 and 60 to desorption pump 70 are discharged to a retention chamber (not shown).

The retention chamber in one embodiment is configured as a cold trap, in which the concentrated stream of VOCs are isolated and recovered as condensed VOC material, depending on the temperature conditions of the cold trap. The cold trap can be provided with a refrigerant source, such as embedded refrigerant coils, or a cooling jacket about the cold trap, to produce such condensate from the gaseous VOC stream contacted therewith. The size of the cold trap and the temperature needed to effectuate condensation can be readily determined by experiment within the skill of the art.

The retention chamber in another embodiment can comprise a vessel containing a purifier medium, such as a chemisorbent selected for undesirable species in the concentrated VOC desorbate, so that the desorbate VOC stream flowed to the retention chamber is purified therein to produce a high purity VOC species. The purified VOC species can be flowed from the retention chamber to a filling station for filling gas storage and dispensing vessels for filling thereof.

As another alternative to the retention chamber, the desorbed concentrated VOCs can be flowed from vacuum desorption pump 70 to a filling station for filling gas storage and dispensing vessels for filling thereof.

In this manner, the VOCs can be captured from the effluent and reclaimed, e.g., passed to directly to storage and dispensing vessels for subsequent use, purified and passed to storage and dispensing vessel or used as fuel in a cogenerator.

Alternatively, the concentrated VOC stream may be flowed from vacuum desorption pump 70 to a centralized abatement unit for the semiconductor manufacturing facility for destruction thereof, from which a finally treated effluent, e.g., air, is exhausted directly to the atmosphere.

It will be recognized that the reclamation and concentration system illustratively shown in FIG. 1 may be varied from the specific arrangement shown, as regards the individual reclamation unit operations. For example, the reclamation and concentration system may use other extraction techniques and other equipment to recover VOCs from the effluent stream discharged from the semiconductor manufacturing facility.

The manifolded adsorber assembly illustratively shown in FIG. 1 may be significantly varied to utilize a greater or lesser number of adsorbent beds relative to the two-bed embodiment shown. The respective beds may be suitably valved and manifolded to carry out cyclic repetitive adsorption/desorption cycles, according to a predetermined cycle time program. Additionally, the adsorber assembly may be a rotor adsorption system that is suitably valved and manifolded to carry out cyclic repetitive adsorption/desorption cycles.

It should be appreciated that the reclamation and concentration system of the present invention may be an “end-of-the-pipe” system or alternatively, a “point-of-use” system. With regards to a point-of-use reclamation and concentration system, a series of adsorbent beds, as described herein, are disposed at each VOC-producing station for reclamation and concentration of VOCs thereof. Each bed is manifolded to a centralized vacuum to effectuate desorption/regeneration of the “off-stream” beds for reprocessing. As such, the VOCs are captured at the locus of generation, thereby maximizing abatement efficiency.

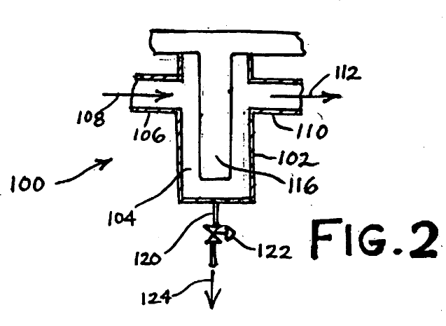

FIG. 2 is a. schematic representation, taken in elevational cross-section, of a cryotrap reclaimer unit 100 adapted for recovery of chemical reagents from the effluent of a semiconductor manufacturing operation.

The cryotrap reclaimer unit 100 may be utilized as a component unit of a reclamation and concentration system of a type as illustratively depicted in FIG. 1, and comprises a retention vessel 102 which is arranged to receive the effluent stream from the semiconductor manufacturing operation, denoted by arrow 108 in inlet 106. Alternatively, the cold trap can be arranged to receive a concentrated stream of VOCs desorbed from the adsorbent vessels. Disposed in the interior volume 104 of the retention chamber 102 is a cold finger 116, which is suitably internally cooled by a cryogen or other refrigerant. The exterior surface of the cold finger 116 thus presents a plating surface for freeze-out of condensable/solidifiable components of the effluent stream, e.g. VOCs, during passage of the effluent stream through the retention chamber interior volume.

In this manner, the effluent stream is depleted of the condensable/freezable components and the resulting effluent, reduced or preferably substantially depleted in such. condensable/freezable components, is flowed out of the retention vessel 102 via outlet 110, the effluent steam being denoted by arrow 112.

Subsequent to plate-out of the condensable/freezable components of the effluent stream, the flow of effluent through retention vessel 102 is terminated and the frozen material can then be liquefied and joined with any condensed material in the retention chamber, for drainage therefrom in discharge line 120 containing flow control valve 122 therein. The recovered liquid, schematically illustrated by arrow 124, may be further purified.

Alternatively, the refrigeration of the cold finger may be discontinued after termination of the effluent flow, and the captured solid and liquid components may then be regasified by warming of the cold finger and retention vessel 102, to suitable temperature such as ambient temperature (e.g., room temperature, e.g., 25-30° C.), and subsequent passage of the regasified material from the retention chamber to a cogeneration unit therein. Alternatively, the regasified material can be collected and subjected to further purification.

It will therefore be apparent from the foregoing description that substantial process gains in the semiconductor manufacturing facility can be achieved by recovery of VOCs in the gaseous effluent discharged from the facility. By such recovery, the energy cost for the semiconductor manufacturing facility can be substantially reduced, the effluent abatement process can be substantially decreased in size and cost, and overall operation of the facility can be dramatically improved by the recovery of VOCs and reuse thereof.

The foregoing suggests that substantial amounts of VOCs can be captured from the effluent stream of a semiconductor manufacturing operation for cogeneration, or for other use or disposition.

Although the invention has been described herein with reference to specific aspects, features and embodiments, it will be recognized that the invention may be broadly implemented and practiced, with respect to variations, modifications, and alternative embodiments, as will suggest themselves to those of ordinary skill in the field of the invention, based on the disclosure herein.

Accordingly, all such variations, modifications, and alternative embodiments are to be regarding as being within the spirit and scope of the invention as hereafter claimed.

1. A gas reclamation system for capturing volatile organic compounds from an effluent of a semiconductor manufacturing operation, said system comprising:
a reversible capture unit arranged to capture volatile organic compounds from the effluent and to selectively release the captured volatile organic compounds in concentrated form, wherein the reversible capture unit comprises a physical adsorbent having a selective sorptive affinity for the volatile organic compounds; and
a vacuum desorption unit arranged to desorb volatile organic compounds from the adsorbent in concentrated form.

2. The gas reclamation system of claim 1, wherein the physical adsorbent is present in a physical adsorbent bed in an adsorber vessel.

3. The gas reclamation system of claim 1, wherein the physical adsorbent is present in a multiplicity of inter-manifolded physical adsorbent beds arranged for cyclic adsorption/desorption operation involving contacting of the effluent to effect adsorption of volatile organic compounds, and subsequent desorption of the volatile organic compounds, wherein each of the inter-manifolded physical adsorbent beds is arranged to operate in accordance with a predetermined cycle time program involving concurrently at least one on-stream physical adsorbent bed engaged in said contacting and at least one off-stream physical adsorbent bed engaged in said desorption of the volatile organic compounds.

4. The gas reclamation system of claim 1, wherein-the vacuum desorption unit maximizes the fuel value of the desorbed volatile organic compounds.

5. The gas reclamation system of claim 1, wherein the pressure of the vacuum desorption unit does not exceed about 700 Torr.

6. The gas reclamation system of claim 1, further comprising a power generator arranged to receive the captured volatile organic compounds to generate electricity.

7. The gas reclamation system of claim 6, wherein the power generator comprises a gas turbine engine.

8. The gas reclamation system of claim 7, wherein the gas turbine engine is a microturbine.

9. The gas reclamation system of claim 8, wherein the microturbine generates about 30 kW to about 60 kW of power.

10. The gas reclamation system of claim 7, further comprising a combustion promoting gas unit arranged to provide the combustion promoting gas to the gas turbine engine.

11. The gas reclamation system of claim 10, wherein the combustion promoting gases comprise oxygen.

12. The gas reclamation system of claim 7, wherein the captured volatile organic compounds undergo combustion in the gas turbine engine.

13. The gas reclamation system of claim 7, further comprising a combustion sustaining fuel unit arranged to provide the combustion sustaining fuel to the gas turbine engine.

14. The gas reclamation system of claim 13, wherein the combustion sustaining fuel comprises a fuel species selected from the group consisting of hydrogen, natural gas and C₁-C₄ alkanes.

15. The gas reclamation system of claim 1, wherein a vacuum pump is disposed upstream of the power generator.

16. The gas reclamation system of claim 1, coupled in effluent receiving relationship to a semiconductor manufacturing process.

17. The gas reclamation process of claim 16, wherein said semiconductor manufacturing process comprises a process selected from the group consisting of photoresist spin coating, isopropanol dryers, wet bench photoresist strip tools, solvent baths, solvent washing stations and combinations of two or more of the foregoing.

18. The gas reclamation process of claim 1, wherein the captured volatile organic compounds comprise a compound selected from the group consisting of saturated hydrocarbons, unsaturated hydrocarbons, aromatic hydrocarbons, esters, ethers, oxygen-containing acids, amines, mercaptans, thioethers, and halogen-containing hydrocarbons.

19. The gas reclamation system of claim 1, wherein the captured volative organic compounds comprise a compound selected from the group consisting of isopropanol, ethylacetate, acetone, propylene glycol monomethyl ether acetate (PGMEA) and hexamethyldisilazane (HMDA).

20. The gas reclamation system of claim 2, wherein the adsorbent bed(s) comprise a carbon sorbent material.

21. The gas reclamation system of claim 2, wherein the adsorbent bed(s) comprise a non-carbon sorbent material.

22. The gas reclamation system of claim 1, wherein the disposition of the captured volatile organic compounds is selected from the group consisting of cogeneration, condensation using a cold trap, purification, filling gas and dispensing vessels and destruction in a centralized abatement unit.

23. A gas reclamation system for capturing volatile organic compounds from an effluent of a semiconductor manufacturing process for cogeneration, said system comprising a physical adsorption unit including at least one adsorber vessel containing a physical adsorbent having selective sorptive affinity for the volatile organic compounds, wherein the physical adsorption unit is arranged to receive effluent containing volatile organic compounds, for selective adsorption of volatile organic compounds on adsorbent therein, and to subsequently desorb volatile organic compounds from the physical adsorption unit; and a power generator coupled to the physical adsorption unit and arranged for receiving a desorbate at least partially concentrated in volatile organic compounds from the physical adsorption unit to generate electricity.

24. The gas reclamation system of claim 23, wherein the power generator comprises a gas turbine engine.

25. The gas reclamation system of claim 23, wherein the volatile organic compounds are desorbed from the physical adsorption unit using a vacuum.

26. A process for improving the efficiency of abatement and/or implementing reclamation and concentration of volatile organic compounds in an effluent of a semiconductor manufacturing process, said process comprising:
capturing the volatile organic compounds from said effluent in concentrated form, wherein the capturing step comprises use of adsorbent bed(s) for capture of the volatile organic compounds; and
releasing the adsorbed volatile organic compounds by vacuum desorption.

27. The process of claim 26, wherein the adsorbent bed(s) comprise a non-carbon sorbent material.

28. The process of claim 26, wherein the adsorbent bed(s) comprise a carbon sorbent material.

29. The process of claim 26, further comprising generating electricity wherein the released volatile organic compounds are directed to a power generator.

30. The process of claim 26, further comprising condensing the released volatile organic compounds in a cold trap.

31. The process of claim 29, wherein the power generator comprises a gas turbine engine.

32. The process of claim 31, wherein the gas turbine engine comprises a microturbine.

33. A method of reclamation and cogeneration of volatile organic compounds in an effluent of a semiconductor manufacturing process comprising:
collecting the effluent containing volatile organic compounds;
selectively adsorbing the volatile organic compounds from the effluent at least partially concentrated in the volatile organic compounds on a physical adsorbent therein;
desorbing volatile organic compounds from the adsorbent to produce a stream of captured volatile organic compounds;
combusting the captured volatile organic compounds in a combustor to substantially destroy the captured volatile organic compounds and create a resulting stream of combustion gas;
directing said resulting stream of combustion gas to drive a power generator; and
recovering power from operation of said power generator.

34. The method of claim 33, wherein the physical adsorbent is carbon.

35. The method of claim 33, wherein the volatile organic compounds are desorbed from the adsorbent using a vacuum.
